(19) United States
(12) Patent Application Publication
(10) Pub. No.: US 2011/0239999 A1
(43) Pub. Date: Oct. 6, 2011

(54) Device for storing energy and transforming energy

(75) Inventor: Werner Steinberger, Rauhenzell (DE)

(73) Assignee: ROBERT BOSCH GMBH, Stuttgart (DE)

(21) Appl. No.: 12/310,739

(22) PCT Filed: Sep. 10, 2007
(86) PCT No.: PCT/EP2007/059484

§ 371 Date: Nov. 19, 2009

(30) Foreign Application Priority Data
Sep. 21, 2006 (DE) 10 2006 044 435.3

(51) Int. Cl. H01F 38/12

(52) U.S. Cl. 123/634

(57) ABSTRACT

A device for storing energy and transforming energy, e.g., an ignition coil of an ignition system of a vehicle, includes: a magnetically active I core; a first coil element which accommodates a first winding that is connected to a supply voltage; a second coil element which has a second winding that is connected to a high-voltage terminal; a peripheral core which encloses the I core, the first winding and the second winding; a permanent magnet which is situated at one end of the I core; a first insulation situated between the permanent magnet and the peripheral core; and a second insulation situated between the other end of the I core and the peripheral core.

### BACKGROUND OF THE INVENTION

1. Field of the Invention

The present invention relates to a device for storing energy and transforming energy, particularly an ignition coil of an ignition system of a motor vehicle.

2. Description of Related Art

Devices for storing energy and transforming energy are known from the related art in different embodiments and are particularly used as ignition coils which represent an energy-transmitting high-voltage source, and are used for controlling spark plugs in internal combustion engines operating on the Otto principle. In such an ignition coil, electrical energy, having a comparatively low supply voltage from a DC voltage vehicle electrical system, as a rule, is converted into magnetic energy which, at a desired point in time, at which an ignition pulse is to be emitted to the spark plug, is converted into electrical energy having a high voltage.

In order to convert electrical energy into magnetic energy, the vehicle electrical system current of the motor vehicle flows through a first coil, which usually is a winding of copper wire. A magnetic field around this coil is created thereby, which has a certain direction and is closed in on itself. For the release of the stored electrical energy in the form of high-voltage pulses, the previously built-up magnetic field is forced into a changed direction by switching off the electrical current, whereby in a second coil, which is located spatially close to the first coil, and which has a much larger number of turns, an electrical high voltage is created. Because of the implementation of the energy, that is now electrical, at the spark plug, the magnetic field built up previously breaks down, and the ignition coil discharges. High voltage, spark current and spark duration during ignition of the internal combustion engine may be established as required by the design of the second winding.

Furthermore, an ignition coil is known from published German patent document DE 103 08 007 which has a magnetically active I core, which is surrounded by a first coil element having a winding that is connected to the supply voltage, and a second coil element that has a winding connected to an high-voltage terminal. Moreover, the device includes a peripheral core that encloses the two coil elements and forms a magnetic circuit together with the I core. In addition, a permanent magnet is situated at the end of the I-shaped core. In this known ignition coil, however, in particular, undesired mounting gaps occur. On this matter, published German patent document DE 103 08 077 proposes positioning the I core and the peripheral core free from gaps. However, this reduces the potential of the peripheral core that is created by the capacitive coupling between the secondary winding and the conversion core, based on the capacitive coupling to the first coil element.

### BRIEF SUMMARY OF THE INVENTION

By contrast, the device according to the present invention, for storing energy and transforming energy, has the advantage that a peripheral core is able to take on a higher potential. Furthermore, the device according to the present invention has no undesired mounting gaps or differently sized gaps based on tolerances of the individual components. The device according to the present invention thus has a peripheral core having a high potential. According to the present invention, this is achieved by placing an insulation between the I core and the peripheral core. In particular, the insulation is provided at the of the I core in the longitudinal direction. Consequently, the insulation assumes the function of an air gap, and separates the I core from the peripheral core. Since the insulation has a specified, constant thickness, no problems occur concerning gap distances of different sizes between the I core and the peripheral core. The device according to the present invention may thus satisfy increased voltage requirements, for instance, in case of future spark plugs, which are used in modern engine concepts, such as turbochargers, direct injectors, lean concepts, spark plug wear, etc. Because of the insulation, the I core may also experience a higher electrically capacitive charge, which leads to a reduced load of an overall insulation of the device, corresponding to the increased charge.

The first and the second insulator are preferably each a thin foil between the I core and the peripheral core. Besides simple producibility, this also has the advantage that the thickness of the foil is constant, so that a specified and constant distance between the I core and the peripheral core is defined.

The foil preferably has a thickness between ca. 30 μm to ca. 100 μm, especially ca. 50 μm. A plastic foil, especially a polyimide foil, is preferably used as the material of the foil. Instead of the foil, one may also use a plastic platelet. According to one additional preferred alternative, the insulation may be produced, for instance, by spraying plastic onto the ends of the I core. Very thin insulators may be produced at the I core by spraying.

According to one example embodiment of the present invention, the peripheral core is developed in a multipart manner. The peripheral core is constructed of essentially L-shaped parts, especially of sheet metal, in this instance.

### BRIEF DESCRIPTION OF THE INVENTION

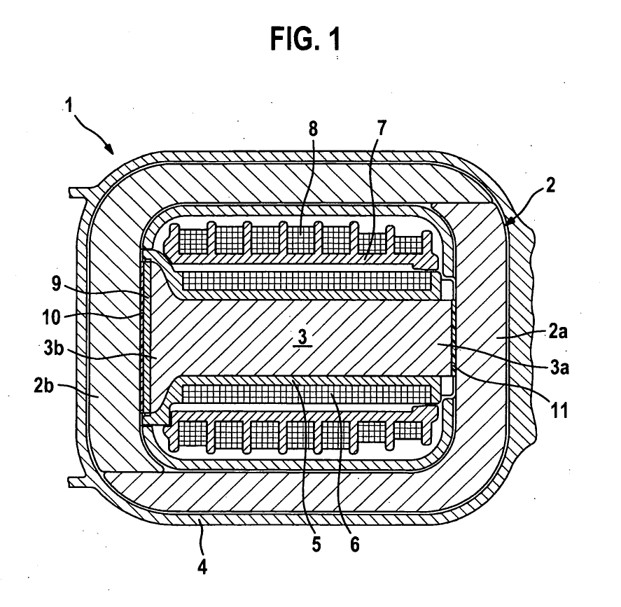

FIG. 1 shows a schematic sectional representation through an ignition coil according to one exemplary embodiment of the present invention.

### DETAILED DESCRIPTION OF THE INVENTION

An ignition coil 1 according to one exemplary embodiment of the present invention is described below, with reference to FIG. 1.

Ignition coil 1, shown in FIG. 1, is a compact ignition coil, including a peripheral core 2 as well as an I core 3.

Peripheral core 2 encloses I core 3 and is produced from a first part 2a and a second part 2b. The two first and second parts 2a, 2b are essentially L-shaped. The peripheral core and the I core are made, for instance, of coated sheet metal. Peripheral core 2 is also surrounded by a housing 4.

A first coil element 5 having a first winding 6 is situated about I core 3, which is supplied with a vehicle electrical system current of a vehicle. A second core element 7 is situated adjacent to first coil element 5, and includes a second winding 8. The number of turns of second winding 8 is very much greater, in this instance, than that of first winding 6. Second coil element 7 surrounds first coil element 5, in this instance.

I core 3 has a first end 3a and a second end 3b. Second end 3b, as shown in FIG. 1, has a greater width than first end 3a. Furthermore, a permanent magnet 9 is situated at second end 3b. Permanent magnet 9 is used for further increasing the magnetic energy. Moreover, at permanent magnet 9, a first insulation 10 is situated. At first end 3a of I core 3, a second insulation 11 is situated. First insulation 10 and second insulation 11 are produced from a thin foil, having a thickness of ca. 50 μm. The foil is a polyimide foil and insulates I core 3 from peripheral core 2. The thickness of the foil is constant over the entire insulation area, in this context. First insulation 10 and second insulation 11 may be fixed in any desired manner, for instance, using adhesion, on permanent magnet 9 and at first end 3a of the I core. Permanent magnet 9 is also fixed on I core 3, using adhesion, for example.

Peripheral core 2 is furthermore situated in housing 4 completely insulated. Electrical charging of the peripheral core is thereby able to take place, which is also called “floating”. Consequently, peripheral core 2 is no longer connected to vehicle ground, and is charged to a potential of a few kV, for example, 2 kV to 4 kV. The advantage of a “floating” peripheral core 2 is that an insulating system between components carrying a high voltage such as the secondary winding provided by second coil element 7 and second winding 8 and contact sheet metals, etc., and peripheral core 2 are unloaded. Furthermore, since an insulation is provided between peripheral core 2 and I core 3, there is thus no conducting connection between peripheral core 2 and I core 3. It is thereby prevented that the potential of peripheral core 2 is reduced by a capacitive coupling with the primary winding, via the I core. Consequently, peripheral core 2 is able to assume a higher potential between ca. 6 kV to 8 kV, so that an insulating system is further unloaded by this potential difference, compared to the related art. Thus, according to the present invention, one may achieve an optimized magnetic circuit of ignition coil 1. Also, according to the present invention, no problems occur related to undesired fluctuations of gap sizes of air gaps.

1-9. (canceled)

10. An ignition coil of an ignition system of a vehicle, comprising:
a magnetically active I core;
a first coil element radially surrounding the active I core, wherein the first coil element has a first winding that is connected to a supply voltage;
a second coil element radially surrounding the first coil element, wherein the second coil element has a second winding that is connected to a high-voltage terminal;
a peripheral core enclosing the I core, the first winding and the second winding;
a permanent magnet situated at a first end of the I core;
a first insulation situated between the permanent magnet and the peripheral core; and
a second insulation situated between a second end of the I core and the peripheral core.

11. The ignition coil as recited in claim 10, wherein the assemblage including the I core, the permanent magnet, the first insulation, the second insulation and the peripheral core is free from air gaps in the longitudinal direction of the I core.

12. The ignition coil as recited in claim 11, wherein at least one of the first insulation and the second insulation is a thin foil.

13. The ignition coil as recited in claim 11, wherein at least one of the first insulation and the second insulation has a thickness of approximately 30 μm to approximately 100 μm.

14. The ignition coil as recited in claim 13, wherein the thickness of the first insulation is equal to the thickness of the second insulation.

15. The ignition coil as recited in claim 13, wherein the peripheral core includes a first part and a second part.

16. The ignition coil as recited in claim 15, wherein the first part and the second part of the peripheral core are each configured to be essentially L-shaped.

17. The ignition coil as recited in claim 13, wherein the first insulation and the second insulation are each formed as a plastic foil.

18. The ignition coil as recited claim 13, wherein the first insulation and the second insulation are formed of a spray-deposited plastic material.
